(19) United States
(12) Patent Application Publication
(10) Pub. No.: US 2007/0156720 A1
(43) Pub. Date: Jul. 5, 2007

(54) System for hypothesis generation

(75) Inventor: Alianna J. Maren, McLean, VA (US)

Correspondence Address: FOLEY AND LARDNER LLP;SUITE 500, 3000 K STREET NW, WASHINGTON, DC, 20007, US

(73) Assignee: EAGLEFORCE ASSOCIATES

(21) Appl. No.: 11/513,358

(22) Filed: Aug. 31, 2006

Related U.S. Application Data
(60) Provisional application No. 60/712,445, filed on Aug. 31, 2005.

(51) Int. Cl. G06F 7/00

(52) U.S. Cl. 707/100

(57) ABSTRACT

A system for performing hypothesis generation is provided. An extraction processor extracts an entity from a data set. An association processor associates the extracted entity with a set of reference entities to obtain a potential association wherein the potential association between the extracted entity and the set of reference entities is described using a vector-based belief-value-set. A threshold processor determines whether a set of belief values of the vector-based belief-value-set exceed a predetermined threshold. If the belief values exceed a predetermined threshold the threshold processor adopts the association.

### CROSS-REFERENCE TO RELATED APPLICATION

The present application claims the benefit of and priority to U.S. Provisional Patent Application No. 60/712,445 (incorporated by reference herein in its entirety).

### SUMMARY

According to a disclosed embodiment, a system for performing hypothesis generation includes an extraction processor configured to extract an entity from an unstructured data set, an association processor configured to associate the extracted entity with a set of reference entities to obtain a potential association wherein the potential association between the extracted entity and the reference entity is described using a vector-based belief-value-set. A threshold processor is configured to determine whether a set of belief values of the vector-based belief-value-set exceed a predetermined threshold. If the belief values exceed a predetermined threshold the threshold processor is configured to adopt the potential association.

According to another disclosed embodiment, a system for performing hypothesis generation includes an extraction processor configured to extract a complex entity from an unstructured data set, an association processor configured to associate the complex extracted entity with a set of complex reference entities to obtain an association wherein the potential association between a complex extracted entity and a complex reference entity is described using a vector-based belief-value-set. A threshold processor is configured to determine whether a plurality of belief values of the vector-based belief-value-set exceed a predetermined threshold. If the belief values exceed the predetermined threshold, the threshold processor is configured to adopt the potential association.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a block diagram of an exemplary system for performing hypothesis generation.

FIG. 2 is a block diagram illustrating examples of simple extracted and reference entities.

FIG. 3 is a block diagram illustrating an example of matching a simple entity to a set of reference entities where both local and global context is employed.

FIG. 4 is a block diagram illustrating an example of cooperative-competitive support for simple entity matching.

FIG. 5 is a block diagram illustrating an example of complex entity matching.

FIGS. 6(A)-(C) represent exemplary reference entities.

FIG. 6(D) represents an exemplary extracted entity.

FIG. 7 is a block diagram of a system for performing hypothesis generation implemented on a physical computer network according to one embodiment of the invention.

### DESCRIPTION

Embodiments of the present invention will be described below with reference to the accompanying drawings. It should be understood that the following description is intended to describe exemplary embodiments of the invention, and not to limit the invention.

The present invention relates generally to the field of knowledge discovery. More specifically, the present invention relates to a system and method for hypothesis generation.

As the world's generation of unstructured, multi-formatted data continues to increase a new need emerges for automatically extracting meaningful information. An overarching need that goes beyond the basic realm of concept-based Knowledge Discovery (KD) is to identify whether a given data item (e.g., a newspaper article, web page, report, TV broadcast, etc.) contributes new or essentially the same information with regard to a known, referenced entity or event. This need encompasses much more than simple data de-duplication. In fact, this approach provides greater access to knowledge-based reasoning, and a greater ability to correctly associate ambiguous and/or context-dependent references.

In order for true knowledge discovery (KD) to proceed in an autonomous or largely autonomous manner, there needs to be a means by which entities expressed in the data items can be determined as corresponding to known, “reference” entities. For example, in some contexts “George W.” is associated with a President of the United States, George W. Bush, and at other times possibly with a new submarine sandwich on the menu of a restaurant. Similarly, if a news article states that “The President will attend the G-8 Summit,” then the hypothesis generation and evaluation capability infers the President of the United States as referenced, and not to, for example, the President of Spain. Unless, of course the article is published by a Spanish newspaper in which case the reference is likely to be the President of Spain. In sum, the above examples illustrate the need for correlating entities found in source data items to known, “reference” entities.

Once entity associations (vice known reference entities) have been hypothesized and evaluated, then it is reasonable to move to the next step, which is to compare the full situation in which the specific entities are embedded against any existing situation frameworks, and to update the belief factors for the entire assertion involving entities and their situation-specific relationships and interactions.

Developing a system for generating entity association hypothesis is important for many reasons. First, as the amount of information increases, there will be increasing value in automating discovery and “capture” of information relating to certain topics. However, on important and/or emerging topics, the amount of information may overload a human who is trying to understand a situation. This can be particularly true for important world events, where multiple reports emerge within rapid time.

For example, the ability to match new situation-descriptive information against some known, or pre-determined “reference situation,” makes it possible to rapidly identify whether a new report contains significant new information, or different information, or essentially replicates known information with no new “value-added.” A system capable of performing the above-described match analysis provides an enormous time-saving value.

Second, there is strong potential value in identifying whether situation reports, purporting to describe the same event from multiple perspectives, actually are essentially the same. There is a potential for “information warfare,” by publishing out purported independent observations of the same situation, where these reports are essentially duplicative. One way in which this could be determined is to use measures for event matching, which in this case shows that the reports were actually too similar; compared to “typical” human reports of the same event, there could be too close a degree of coherence.

Third, as situations evolve, they can change. Also, multiple similar situations could evolve, and potentially be confused with each other. As an example, during the unfolding of the Sep. 11, 2001 crisis, the attack on the first tower of the World Trade Center was a single event. The attack on the second tower was a separate, although related event. It is important, when multiple reports are coming in describing rapidly evolving, and potentially chaotic, situations, to have a mechanism for determining whether the report contains new information about a single, ongoing situation—or if describes a new, although similar or related situation.

During times of stress, human analysts may not have sufficient time to correctly discern the value of any new information report. A system capable of generating an automated “situation match” against a (set of) known, reference situation(s) can increase accuracy and improve confidence in human situation understanding and decision making.

According to one embodiment of the invention a system and methodology for accumulating evidence with regard to entity association to a known, reference entity, and also to known, reference events or situations is provided. Further, if the entity or event/situation being nominated for match differs significantly from extant reference entities or events/situations, a new reference entity or event/situation can be posited by the system.

According to one embodiment of the invention, hypothesis generation system is provided for formulating the overall means by which a match between a simple entity—that is, a single person, place, organization, or thing, extracted from an information source (e.g., web page, report, etc.) corresponds to a known and referenced simple entity, and for formulating a means by which a match between a complex entity (an event or situation) described in an information source corresponds to a known and referenced complex entity.

Five core technologies contribute to the hypothesis generation and valuation method and system. Those technologies are Knowledge Discovery, Ontologies and taxonomies, classifier (supervised learning) methods, neurophysiology of focus and attention, and evidential reasoning.

The role of Knowledge Discovery (KD) as fully described in U.S. patent application Ser. No. 11/059,643 is to identify those data elements from large corpora where there are concepts, and potentially entities, of interest. The role of ontologies and taxonomies is to provide a framework by which context-determination methods (as Level 4 processes of the KD system) can yield the “clues” on which the evidential reasoning methods will operate. The role of classifier methods is to suggest means by which specific entities can be matched against known, reference entities. The role of neurophysiology is to suggest architectures and mechanisms by which more complex processes and associations can be formulated. The role of evidential reasoning is to both aggregate evidence in support of a given assertion (hypothesis verification), and also to identify conflict between evidence items, which could yield a lower valuation on an initially proposed hypothesis.

A preferred approach to evidential reasoning makes use of Dempster-Shafer (D-S) methods, which provide a means of evidence aggregation within an overall decision-support architecture. D-S methods allow for explicit pairwise combination of “beliefs,” including measures of uncertainty and disbelief in a given assertion. While the need for a decision tree governing selection of pairwise elements for combination can require development of a substantial rules set to cover all the possible cases for obtaining different evidence combinations, this can actually prove to be an advantage in the sense that each time an evidence-unit is requested from a specific source, it is possible to pre-compute the additional cost. It is also possible to specify in advance how much a given additional form of evidence will be allowed to contribute to the total belief. This means that cost/benefit tradeoffs for collecting different forms of evidence from different sources can be assessed, leading to a rules set governing evidence-gathering.

Certain additional factors support selection of the Dempster-Shafer method. The D-S method does not require rigorous specification of priors (as is needed with Bayesian methods). The Principal of Minimal Commitment holds, which is a means by which no belief-state is ever given more support than is justified, and this means that uncertainty about state or classification selection can be preserved which has significant importance in numerous applications. The expansion process allows for addition of new beliefs without retracting any old beliefs, which is essential as additional evidence is gathered for any belief-state (related to the rules for combination). Different levels of abstraction can be combined as evidence (which is very difficult for many applications, viz. sensor fusion, knowledge discovery in linguistic and/or image data, etc.), and evidence commutability is preserved for any combination of pieces of evidence and with any “conditioning,” or valid belief assertions that impact other belief determinations.

U.S. patent application Ser. No. 11/279,465, incorporated by reference, addresses three key issues involved in using the Dempster-Shafer approach, which are (1) means to assign initial values for aspects such as disbelief or uncertainty, as well as the more common belief, (2) means to provide clear assignment to a decision or classification given various belief values (belief, disbelief, and uncertainty, along with conflict), and (3) means for adapting the decision to an overarching framework encompassing the context and constraints within which the decision must be made.

Further, evidence accumulation should be traceable, both uncertainty and conflict in potential decisions/assignments should be represented explicitly, there should be a defined means for accumulating additional evidence to support potential assertions, so that a “minimal-cost” set of rules for obtaining evidence can be applied (assuming that each “evidence unit” carries an associated cost), and there should be a means to cut-off further evidence accrual after sufficient evidence has been obtained to support a given assertion, while the uncertainty and/or conflict about this assertion are within acceptable and defined limits.

One specific reason to adopt the Dempster-Shafer method for evidence aggregation is that in advancing to a more complex evidence aggregation method, such as Dempster-Shafer, the decision-making process is more complex. Ideally, the decision to positively classify an entity as being a member of a certain class is the result of having sufficiently high belief (B>Δ₁), a sufficiently low disbelief (or sufficiently high plausibility, which amounts to the same thing), and a sufficiently low conflict (between belief/disbelief as asserted by different evidence sources.)

Initial evidence assignment values and determination of decision-point thresholds-are intrinsic to use of the D-S method. These are fully addressed within U.S. patent application Ser. No. 11/279,465. The system and method described in this patent application provides a mechanism for dealing with the more complex hypothesis generation and valuation process, based on the valuations of a given belief-set.

Following a formalism introduced by Devlin (Logic and Information, K. Devlin, 1991), the notion of a situation as a generalized entity, and that of an infon to denote an “information object,” or “information primitive” is introduced. The notion of a belief is used to express external belief about a given situation.

An infon σ is denoted as: [symbol] [symbol]
P,a₁,a₂, . . . ,aₙ,i [symbol] [symbol]
where P is the proposition, a₁, . . . , aₙ is the set of relationships or attributes attached to the proposition, and i is an index that tells whether the proposition and its associated attributes is either true (i=1), or not-true (i=0).

A situation s is denoted as:
s|=σ

Devlin introduces the notion of a belief B as a “particular intentional mental state,” which has both external content (the proposition P), as well as a structure, given as S(B).

The structure, S(B), of belief B is denoted as: [symbol]
Bel,e^{#},P^{#},t^{#},i [symbol]
where:

Bel identifies this as a belief (as opposed to a desire, or other intentional state),

e identifies the specific environment in which the belief is supposed to occur (and may in some circumstances be unspecified, in which case it is denoted as “-,”) and

e^{#} refers to a notion of a specific environment, which may not be an actual, realizable environment itself (e.g., one can have a “notion” of how a storyline will play out, or what the conditions on a golf course may be, etc.),

P identifies a proposition, and P^{#} refers to a notion of a specific proposition, e.g., “It is raining,”

t identifies the time, and t^{#} refers to a notion of a specific time, e.g., “now,” i is a unary value as to whether the belief in the proposition, occurring in the referenced environment, at the referenced time, is true or false.

In addition to these formalisms developed by Devlin (1991), the description also makes use of a notation drawn from the work of Dempster-Shafer, specifically a belief-value-set for belief A, denoted as the vector variable ε, where the vector consists of:
ε= ε̅_{A,i}=└Y_{A,i},N_{A,i},C_{A,i}┘
where:

Y_{A,i} is the belief in assertion A at the i^{th} step of evidence accumulation,

N_{A,i} is the disbelief in assertion A at the i^{th} step of evidence accumulation, and

C_{A,i} is the conflict in assertion A at the i^{th} step of evidence accumulation.

Note that this is a minimal specification for a belief-value-set encompassing the variables used in Dempster-Shafer logic. When the discussion concerns a single assertion, the subscript A can be dropped. Further, if the specific step of evidence accumulation is not germane to a given discussion, the subscript i can also be dropped.

The belief-value-set variables are further governed by the constraint that:
Y+N+U=1,
where the variable, U_{A,i} is the uncertainty in assertion A at the i^{th} step of evidence accumulation, and for known assertion and processing step, can be referred to as U.

The following two variables are also useful:

“Plausibility,” Pl is given as Pl=Y+U=1−N, and

“Doubt,” D is given as D=N+U=1−Y.

When appropriate, these variables can be subscripted in the previously-described manner.

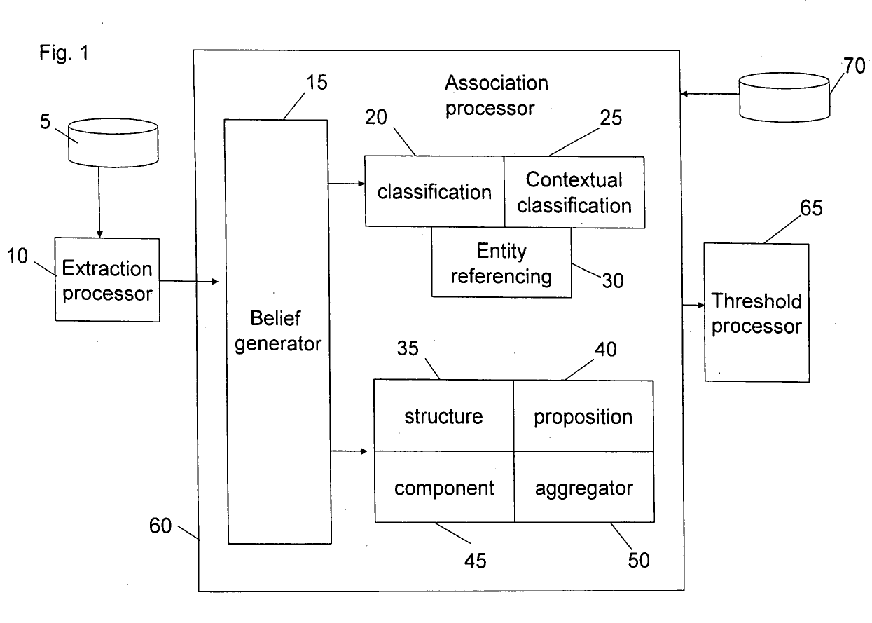

FIG. 1 is a block diagram of a system for performing hypothesis generation according to one embodiment of the invention. It should be understood that each component of the system may be physically embodied by one or more processors, computers or workstations, etc. having memory and configured to execute software. A physical embodiment of the system, according to one embodiment of the invention, illustrated in FIG. 1, is shown, for example, in FIG. 12, wherein the plurality of components are computers 1215, 1120, 1225, 1230, 1235 and one or more external data sources 1240 interconnected via a network 1200. A user may access the system via a user terminal 1210 that may be configured to run a web browser application.

As shown in FIG. 1, an extraction processor 10 extracts an entity form a set of data 5. The data 5 may be structured (e.g., a database) or unstructured (e.g., an article). The extraction processor 10 feeds the extracted entity to an association processor 60. The association processor 60 also receives as input a set of reference entities which may be extracted from a reference entity data set. 70. A belief generator 15 generates an initial belief about whether the extracted entity is related to a reference entity. For simple entities, the initial belief is analyzed using a classification 20, context classification 25, and entity referencing processor 30 to generate a belief-value-set. For complex entities, the initial belief is analyzed using a structure comparison 35, proposition 40, component 45, and aggregation 50 processor to generate a belief-value-set. The generated belief-value-sets are analyzed using the threshold processor 65 to determine whether the initial belief should be accepted by the hypothesis generator system. The above-described components and there operation will be further described below.

According to one embodiment of the invention, a hypothesis generation system and method is provided to associate a simple extracted entity with a simple reference entity. A “belief-value-set” is provided in the association between the extracted entity and the reference entity. Unstructured data surrounding the extracted entity and a combination of structured and/or unstructured data is used to describe the reference entity. A mathematical means is used for describing a potential association between an extracted entity and a given reference entity, where the likelihood of association is described using a Dempster-Shafer-based “belief-value-set.”

According to another embodiment of the invention, a hypothesis generation system implementing a classifier-based system and method is provided for describing both the extracted and referenced entities, where the classifier is further correlated with a taxonomy of concepts, each node of which can be described via a classifier-based method. In addition, a system and method is provided for establishing association using a classifier method with local and global context and, and a means for augmenting belief in entity-to-entity association is provided, using “cooperative/competitive” inputs from neighboring entities which either have been associated to reference entities, or are themselves undergoing the association process.

According to yet another embodiment of the invention, a hypothesis generation system and method is provided to associate a complex extracted entity with a complex reference entity. A “belief-value-set” is provided in the association between the extracted entity and the reference entity. Unstructured data surrounding the extracted entity and a combination of structured and/or unstructured data is used to describe the reference entity. A mathematical means is used for describing a potential association between an extracted entity and a given reference entity, where the likelihood of association is described using a Dempster-Shafer-based “belief-value-set.”

In the case where an entity of interest is simple, e.g., a person, place, or thing, an “equivalence infon” simply asserts that the extracted entity corresponds with a certain reference entity. According to one embodiment of the invention, a new kind of infon is defined as an equivalence infon, which represents an equivalence between an extracted entity and a reference entity. In the subject embodiment, the extracted entity and the reference entity is a simple entity (e.g., person, place, organization, or thing). According to another embodiment of the invention, to be addressed in later paragraphs, the “entity” can be a complex entity such as a situation.

For example, suppose that an equivalence infon is that the extracted entity “George W.” corresponds with the reference entity “George W. Bush, the 43^{rd} President of the United States.” The infonic proposition P is written as:
s|= [symbol] is-same-as,“GeorgeW.”,GeorgeW.Bush-43rd President,1

[symbol]

Given the proposition above, the structure of a belief statement is:
S(B)= [symbol] Bel,-,s,-,i

[symbol]

According to one embodiment of the invention, the unary value i in the belief statement is replaced with a vector-based belief-value-set ε, so that the belief statement structure now carries with it a “degree of belief” represented by the vector ε, as opposed to the simpler unary value i. By using the belief-value-set ε, both a positive degree of belief and a negative degree of belief are indicated, along with the “conflict” between these two beliefs. Accordingly, the structure of a belief statement given by the belief generator is:
S(B)= [symbol] Bel,-,s,-,ε

[symbol]

The task is then to compute a belief-value-set ε such that if this belief is to be “adopted” (i.e., accepted and used for further work or suppositions) by the threshold processor, then the various belief values have to meet and/or exceed certain defined thresholds, that is,
Y≧Δ₁,N≦Δ₂(or Pl=Y+U≧Δ₃),and C≦Δ₄.

According to one embodiment of the invention, a hypothesis generator system for generating a “satisfying belief set” is provided. A “satisfying belief set” is a requisite set of belief values that meet or exceed one or more specified thresholds.

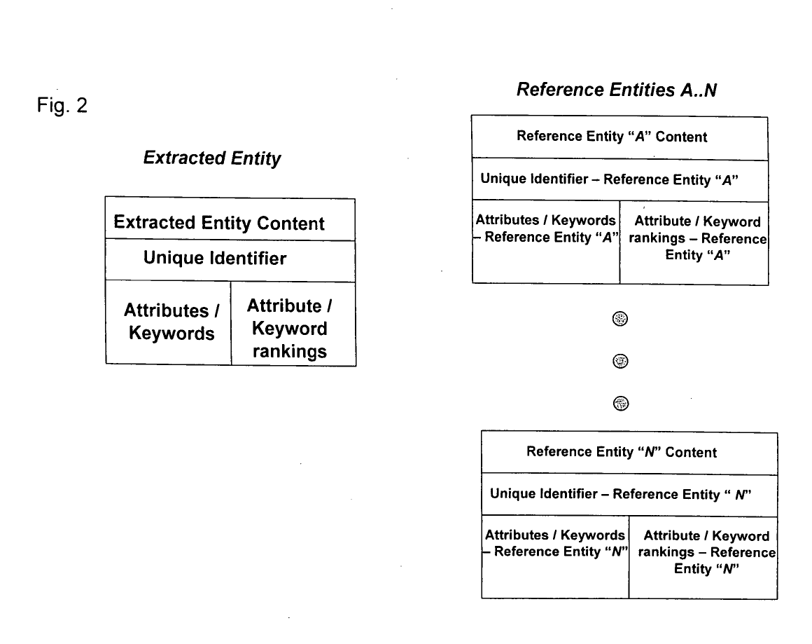

One means by which the development of a “satisfying belief set” can be accomplished is through gathering evidence uniquely associated with the extracted entity, and correlating it with material pre-associated with the reference entity. In the case of structured data, this is accomplished by matching (using any of the means well-known to practitioners of the art) the data fields for the extracted entity with those of the reference entity. As shown in FIG. 2, the classification processor accomplishes the matching of simple extracted entities to simple reference entities by comparing the attributes/keywords related to an extracted entity with the attributes/keywords of one or more reference entities. Preferably, the attributes/keywords for the extracted entity and reference entity are ranked in order to facilitate more accurate matches.

Matching entities taken from unstructured data (e.g., a newspaper article) is more complex. According to one embodiment of the invention, a set of “noun phrases” or other “key words” can be extracted from both the neighborhood immediately surrounding the extracted entity that is being matched, and from the entire data source from which the entity has been extracted. The “noun phrases” and “key words” can be ordered (using one or more methods well-known to practitioners of the art) so that a “concept definition” is provided, typically with a set of key phrases and their relevancies for a Bayesian concept classifier. More generally, the noun phrases immediately around a given extracted entity are best suited for describing that entity. (Multiple sets of such “local” noun phrases can be aggregated and normalized if the same entity is extracted at various locations from the same data source.) The “concept definitions” associated with the extracted entity can then be matched against the “concept definitions” associated with the reference entity.

It is noted that any given reference entity may have multiple contexts. For example, President Bush may occur in the context of his relationship with same-party political figures, with members of his cabinet, with foreign dignitaries and heads of state, and with his family. He could also be associated with entirely different concepts—such as, his golf game. Each of these contexts provides a different “concept categorization.” In order to select the best possible concept set for a given reference entity, it is useful to know the context in which the reference entity appears.

According to one embodiment of the invention, a contextual classification generator is provided for identifying the context and determining which set of concept sets should be used for belief determination, as global context. The concept sets drawn from material immediately surrounding the extracted entity (or aggregated and normalized across multiple extractions of the same entity) are identified as local contexts.

The appropriate context for selecting a reference entity's concept set can be determined by selecting the context which best matches the overall context from which the extracted entity is taken. This means, if the extracted entity “George W.” comes from an article about the President's family, then the reference concept set for the extracted entity “President Bush” should be the one identifying his family relations. If the extracted entity “George W.” comes from an article about the interactions of the President and a foreign head of state, then the reference concept set for President Bush should be the one identifying his role in interacting with other national leaders.

According to one embodiment of the invention, there are several methods available for determining global context. One method is to identify the set of concepts described within the information source. Identification can be done using what has been previously described in U.S. patent application Ser. No. 11/059,643 as “Level 1 processing.” In one embodiment of “Level 1 processing” sets of concepts associated with the source are identified using pre-defined concepts organized according to a pre-defined taxonomy. “Level 1 processing” produces a set of ranked concepts describing the content of the information source. This set of concepts is matched against a (typically) predetermined ontology/taxonomy. The portions of taxonomy which are matched (even partially) then indicate a set of related concepts that could then be used to specify overall context, again by a variety of suitable methods.

Yet another method is to use a “context determination algorithm,” typically based on matching a ranked set of extracted terms against a large set of such similar extractions, where each member of this large set serves as a “context reference.” According to one embodiment of the invention, “Level 4 processing,” as identified in U.S. patent application Ser. No. 11/059,463 may be used to perform the context determination algorithm.

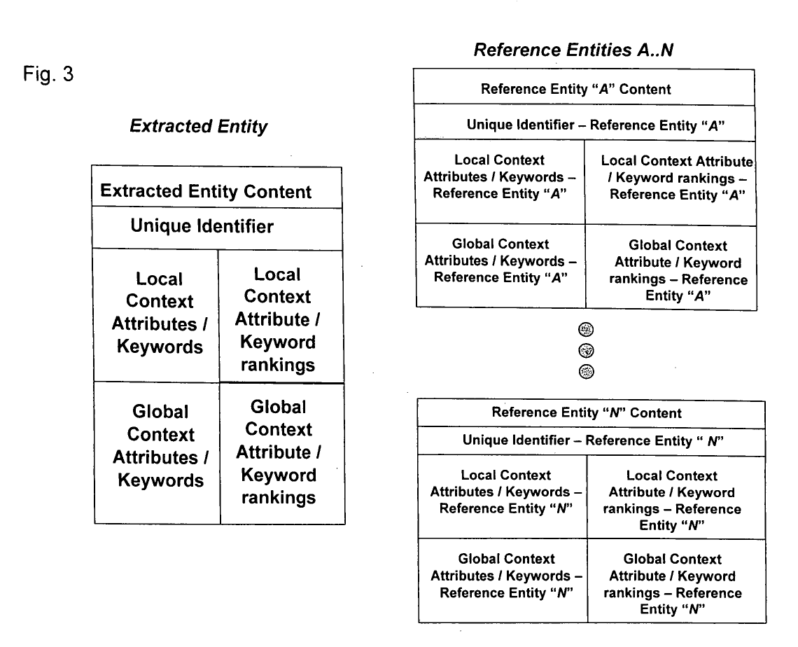

Once global context has been determined, the global context can be used to determine the set of concepts that are most likely relevant for matching the local context surrounding an extracted entity to the most appropriate descriptors for the selected reference entity. One means for accomplishing this is to use global context for the information source to select the appropriate taxonomy for describing the reference entity, then use that taxonomy to provide an appropriate concept set. (E.g., in the afore-mentioned example, concepts for President Bush in his role as a family member would include identifications of his relationships; e.g., wife, two daughters, father, etc.) Belief set development would reasonably begin with matching a concept set based on local context, or noun phrases around the entity “George W.” with a concept set selected around the reference entity “President Bush” in his family taxonomy-context. FIG. 3 is a shows an extracted entity defined using attributes/keywords in a local and global context being compared to one or more reference entities defined using attributes/keywords in a local and global context.

The methods described above lead naturally to a second means for determining belief sets for entity matches. This second method depends less on defining and concept sets for the extracted entity and the reference entity (essentially a form of Level 1-based matching), and deals more with how both the extracted and reference entities are related to other entities.

According to one embodiment of the invention the association processor further comprises an entity referencing processor that identifies each entity, both the extracted and reference, as situated in a relationship-matrix with other entities. As correlations between extracted and reference entities grow, not just for a single extracted entity and its associated reference, but for a suite of both extracted and reference entities, growing belief in one association can assist the belief in another, and vice versa.

According to one embodiment of the invention, the entity referencing processor may apply a method such as described in: A. J. Maren & V. Minsky, “A Multilayered Cooperative-Competitive Neural Network for Segmented Scene Analysis,” in the Journal of Neural Network Computing, Winter, 1990 (14-33).

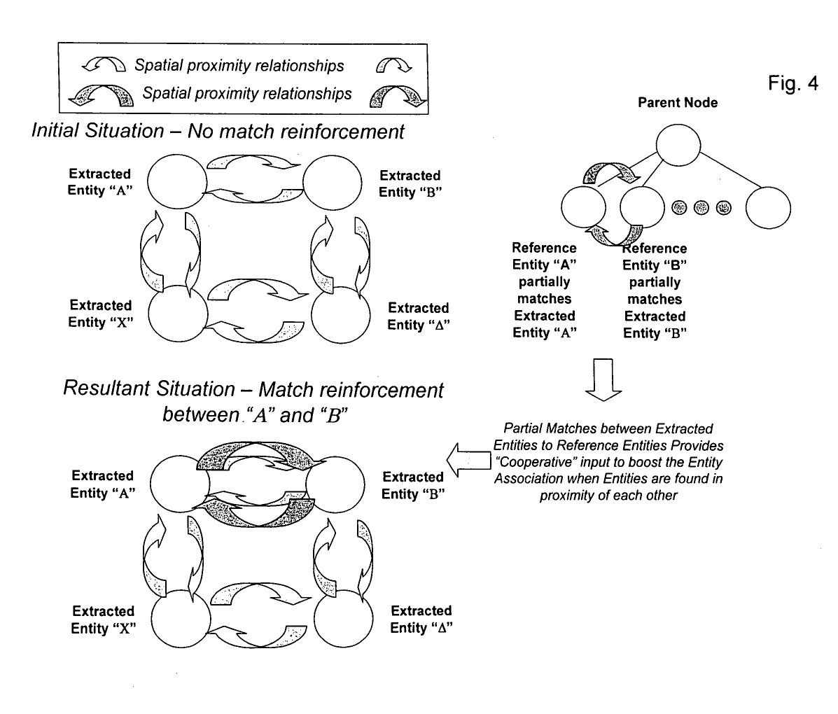

According to this method, and as shown in FIG. 4, a multilayered cooperative-competitive neural network method such as described in the preceding reference can be adapted to provide inputs to an evidence aggregation function, where the whole or partial matches of a given extracted entity to a reference entity not only provide support to matching that particular entity, but also provide support for matching additional extracted entities that are in some form of relationship (e.g., spatial proximity, etc.) to the initial extracted entity. As this process can also happen in reverse, this becomes a method for providing mutual support for increasing belief. The value of the belief grows when the reference entities are also related to each other in some manner (e.g., sibling nodes under the same taxonomic parent, in a taxonomy whose use is supported by the global context of the information source.) The disbelief can also be increased when a whole or partial match to the reference nodes is not found, or when there is evidence to contradict such a match.

The subsequent paragraphs deal with the situation where the extracted entity, and correspondingly the reference entity, is more complex than a “simple” (i.e., unary) extracted entity, and yet is well-describable using the methods of syntactic decomposition. These entities are typically “events” or “situations.”

When matching simple entities (e.g., single persons, organizations, places, things, etc.) against known or reference entities, the belief-value-set ε is typically sufficient to capture the belief in a given hypothesis, or potential assertion, that the extracted simple entity is a match to a given reference entity. (Note that the extracted entity is either one extracted from unstructured text via any of the available entity extraction methods, or accessed from a structured database of entities and their attributes.)

However, the hypothesis generation system also deals with the more challenging situation where the entities to be matched are not simple, but are complex; i.e. entities which are events or situations. In this case, the challenge requires more than matching one simple entity against another. The overall match must encompass the structure of the two complex entities, including the nature of the specific component entities, as well as the nature of the relationship(s) or the proposition.

Thus, the first step is to identify a formal methodology for describing these more complex entities. For this purpose, the selected method is to use the formalism originally described by Devlin (1991) to denote a basic element of information as an infon, which is the smallest unit for describing a situation comprising both a proposition and one or more attributes.

Selecting a formalism to represent the entities that are to be matched only “prepares the ground” for the task of complex entity matching. One of the most challenging aspects in matching one structure to another lies in determining precedence. In this context, precedence refers to which task should be done first: matching structure (syntax), matching relationship(s), or matching component entities.

According to one embodiment of the invention the precedence for matching complex entities is as follows: (1) Match the overall structure from a syntactic or graph-theoretic perspective, (2) match the proposition, or relationship(s), and (3) match the component entities and/or attributes.

Accordingly, the hypothesis generation system adopts the approach of building a structured representation of beliefs, or evidence, along with building a structured representation of the items “discovered” in an information source. This approach initially yields an “evidence-structure,” or “belief-structure,” rather than a scalar, or even a vector. However, a simpler form for representing evidence is necessary. Therefore, the hypothesis generation system uses evidence-combination, according to a Dempster-Shafer formalism, to create a “composite” or “aggregate” belief-value-set.

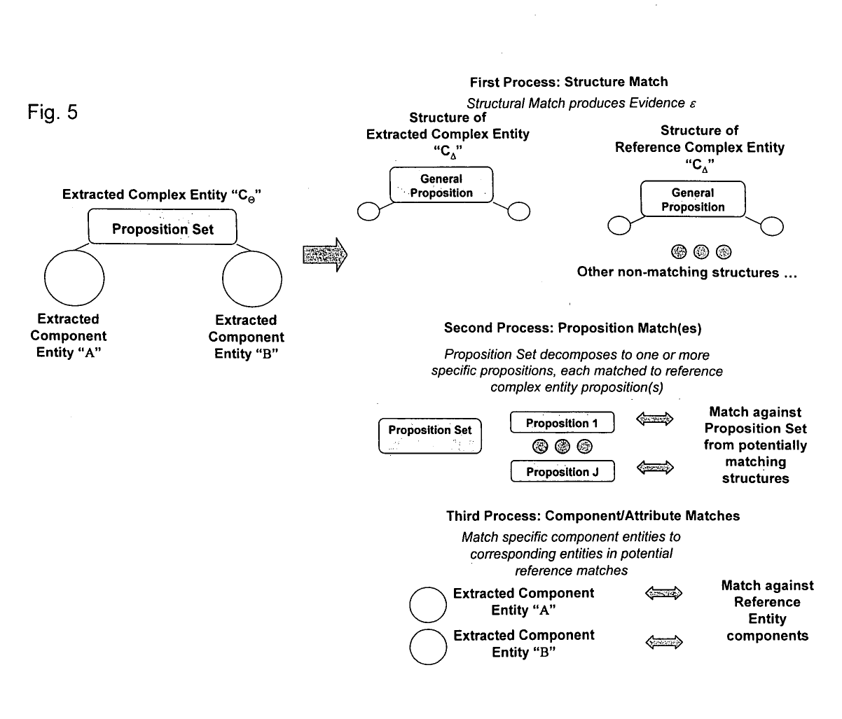

The system and method for creating the belief-value-set for matching an extracted complex entity against a reference complex entity is shown for example in FIG. 5 and is thus described in three major sections: (1) An overall system and method to represent match of the structures against one another, (2) A system and method to represent the match between the extracted entity “relationship(s)” or “proposition” against those of the reference entity, along with matching component entities (attributes), and (3) a system and method to combine the beliefs associated specifically with structure matching, relationship or proposition matching, and component entity matching to arrive at a simpler or “aggregate” belief-value-set.

The hypothesis generation system can be illustrated using the following two examples.

The task of matching entities based on their syntax or structure is illustrated using the following examples. Note that syntax or structure matching applies to both visual and linguistically-based entities. In the case of visual items, the syntax is based on perceptual organization, and in the case of linguistic entities, it can be based on sentence structure, whether “shallow” or “deep.”

Three “reference entities,” identified as the complex entities Cᵢ, are used to illustrate differences in syntax or structure:

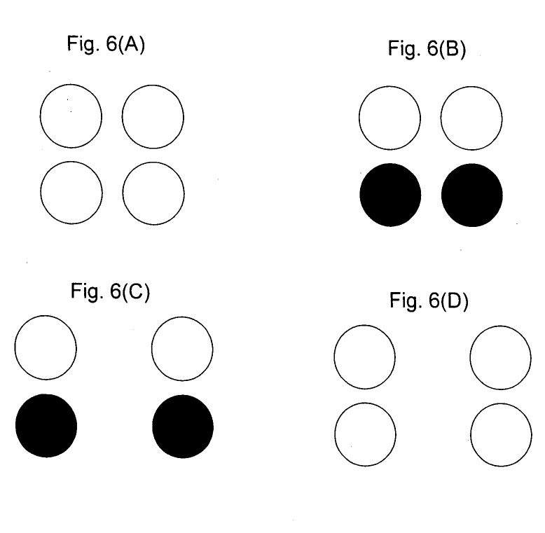

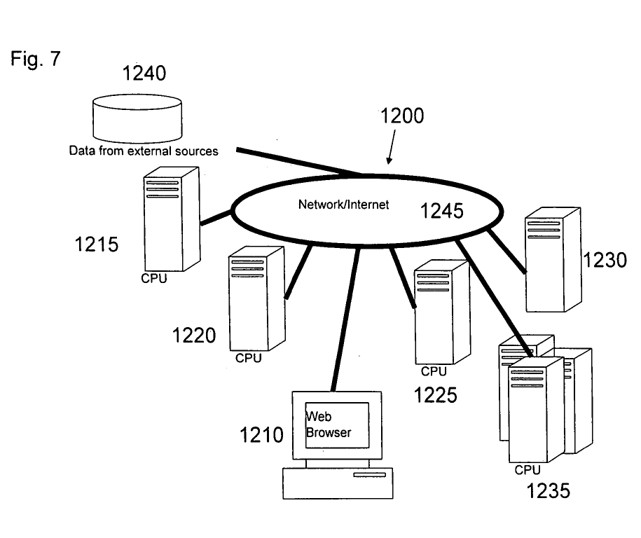

FIG. 6(A) shows a Reference Complex Entity a (Cₐ): Four circles, equidistant from each other; same size and color.

FIG. 6(B) shows a reference Complex Entity b (C_{b}) Two sets of two circles each; all are equidistant from each other, where the two in one set are black, and two in another set are white.

FIG. 6(C) shows a reference Complex Entity c (C_{c}): Two sets of two circles each; black and white close to each other, then the two groups separated by a distance.

Against these three reference entities, the “extracted” complex entity Ce is posited. FIG. 6(D) shows the extracted Complex Entity θ(Cθ): Two sets of two circles each; all the same color, but the two groups separated by a distance.

To make this process more clear, the following paragraphs use the infon approach to describing each of these reference complex entities.

Describing the syntactic/structural nature of Reference Complex Entity a (Cₐ) yields:
σₐ= [symbol] Πₐ,a₁,a₂,a₃,a₄,1,1

[symbol]

Where the relationship proposition Πₐ is given as simply as “has close relationship with” (inferring that they are sufficiently closely related to be forming a structural unit together). Πₐ is specified in greater detail in succeeding paragraphs. The four “attributes” of the proposition, a₁, . . . , a₄, refer to the four elements in FIG. 6(A). The first unary value “1” denotes that this infon is structurally complete at this level; that none of the attributes aᵢ require further decomposition. The final unary value “1” denotes that this infon expresses a “positive belief” that the structure of Cₐ is defined by this description.

Note that this infon formalism has an additional element from the one proposed by Devlin; the inclusion of a unary value to identify whether or not this is a complete structural or syntactic description.

Describing the syntactic/structural nature of Reference Complex Entity b (C_{b}) yields:
σ_{b}= [symbol] P_{b,1},b₁,b₂,0,1

[symbol]

Where the relationship proposition P_{b,1} Π_{b} is given simply as “has close relationship with” (inferring that they are sufficiently closely related to be forming a structural unit together), and is specified in greater detail in succeeding paragraphs. The two “attributes” of the proposition, b₁ and b₂, refer to the two sub-groups elements in FIG. 6(B). The first unary value “0” denotes that this infon is structurally incomplete at this level; that one or more of the attributes bᵢ require further decomposition. The final unary value “1” denotes that this infon expresses a “positive belief” that the structure of C_{b} is defined by this description.

The structural description for C_{c} is similar to that for C_{b}. The structural description for C_{θ} is similar to that for C_{b} and C_{c}.

The matching of the “extracted complex entity” θ(C_{θ}) against the three reference entities Cₐ, C_{b}, and C_{c}, leads to first syntactic matching and only secondly to perceptual/semantic matching, in which the relationships are examined more deeply.

In this example, the match of C_{θ} to Cₐ fails at the syntactic level. Although all four component entities are the same, their structural organization is sufficiently great that the syntactic organization takes on a more complex structure. This basic form of syntactic matching can be accomplished by various means, known to practitioners of the art. The resulting “degree of match” is identified as low, and the disbelief in the match relatively high. There is, however, a substantial component to the “conflict” measure, as there is some evidence to support the match—this comes from component matching as a following process.

In this set of examples, the matches of C_{θ} to C_{b} and C_{c} both succeed at the structure level, leading to a follow-on match of C_{θ} to C_{c}. The “winning” match requires that evaluations be made of both the relationships and the component entities.

It is illustrative, before examining the proposition/relationship match, to identify a way in which the match of C_{θ} to C_{b} and/or C_{c} would play out, on a structural basis alone.

The first step is to assert their equivalence, using the hypothesized belief that C_{θ} could be a match to C_{c}:
s|= [symbol] is-same-as,C_{θ},C_{c},1

[symbol]

A potential belief situation, s_{θ}, is defined formally as:
s_{θ}|= [symbol] has-belief,Analyst,B,-,ε [symbol]
ˆ [symbol] [symbol] has-structure,B, [symbol] Bel,-,P^{#},c₁^{#}, c₂^{#},-,1 [symbol] ,1 [symbol] [symbol]
ˆ [symbol] [symbol] of,P^{#},P_{θ},P_{B},1 [symbol] [symbol]
ˆ [symbol] [symbol] of,b₁^{#},b₁,b₁,1 [symbol] [symbol]
ˆ [symbol] [symbol] of,b₂^{#},b₂,b₂,1

[symbol]

[symbol]

In this notation, references to both external environment and time are left undefined.

Clearly, without yet defining the specific values, some quantifiable notation can be made for the match between the relationship and the component elements.

The specifics of how the match is constructed, including aggregation across the belief-value-sets for the proposition/relationship along with those of the component entities, is given as the final step of describing this invention. The immediately following paragraphs address how the proposition/relationship(s) is(are) compared.

According to one embodiment of the invention, there can readily be multiple kinds of relationships between any two or more given entities. That is, given entities A and B, with some set of relationships between them, the syntactic (or graph) structure of each of the events of A relating to B could be identical, with different relationships being the only difference between them.

Further, while the component entities of an event or situation can indeed be complex, ambiguous, or change over time, it is the relationships that are more likely to be multi-valued and complex. Therefore, the hypothesis generation system uses the approach of establishing precedence for representing the proposition (relationship) first, and the specific component entities as more subordinate.

The first example of this is based on the complex entities described in the previous section.

Addressing the perceptual/semantic nature of Cₐ, the proposition Πₐ decomposes into multiple relationships. Breaking down the basic structural infon for Cₐ yields:
\tilde{σ}ₐ= [symbol] \tilde{P}_{a,1},a₁,a₂,a₃,a₄,1,1 [symbol]
ˆ [symbol] \tilde{P}_{a,2},a₁,a₂,a₃,a₄,1,1 [symbol]
ˆ [symbol] \tilde{P}_{a,3},a₁,a₂,a₃,a₄,1,1 [symbol]
ˆ [symbol] \tilde{P}_{a,4},a₁,a₂,a₃,a₄,1,1

[symbol]

where \tilde{P}_{a,1} denotes that the relationship is regular/equidistant, \tilde{P}_{a,2} denotes that the component elements are “same-size-as,” and \tilde{P}_{a,3} denotes that the component elements are “same-shape-as” each other, and \tilde{P}_{a,4} denotes that the component elements are “same-color-as” each other.

In contrast to Cₐ, C_{b} is a more complex structure, not all of which is exposed at the top level. Here, the relationship proposition Π_{b} is given as simply as the collection of relationships, fully denoted in the following infon:
\tilde{σ}_{b}= [symbol] \tilde{P}_{b,5},b₁,a₂,0,1 [symbol]
ˆ [symbol] \tilde{P}_{b,2},b₁,b₂,0,1 [symbol]
ˆ [symbol] \tilde{P}_{b,3},b₁,b₂,0,1 [symbol]
ˆ [symbol] \tilde{P}_{b,6},b₁,b₂,0,1

[symbol]

where \tilde{P}_{b,5} denotes that the relationship is one of proximity (but not equidistance, since only two components are involved in this structure), \tilde{P}_{b,2} denotes that the component elements are “same-size-as,” and \tilde{P}_{b,3} denotes that the component elements are “same-shape-as” each other. As the two components—each a complex entity—have different colors from each other (grouping solely on white vs. black) the “same-color-as” relationship does not hold. Additionally, there is a new relationship: \tilde{P}_{b,6} denotes that the component elements are “same-orientation-as” each other. A further infon now has to describe the internal structure and perceptual/semantic nature of the complex components (here identical) b₁ and b₂.

C_{c} is a complex structure similar to C_{b}, so again, not all is exposed at the top level. Here, the relationship proposition Π_{c} is given as simply as the collection of relationships, fully denoted in the following infon:
\tilde{σ}_{c}= [symbol] \tilde{P}_{c,5},b₁,a₂,0,1 [symbol]
ˆ [symbol] \tilde{P}_{c,2},b₁,b₂,0,1 [symbol]
ˆ [symbol] \tilde{P}_{c,3},b₁,b₂,0,1 [symbol]
ˆ [symbol] \tilde{P}_{c,4},b₁,b₂,0,1 [symbol]
ˆ [symbol] \tilde{P}_{c,6},b₁,b₂,0,1

[symbol]

where \tilde{P}_{c,5} denotes that the relationship is one of proximity (but not equidistance, since only two components are involved in this structure), \tilde{P}_{c,2} denotes that the component elements are “same-size-as,” and \tilde{P}_{b,3} denotes that the component elements are “same-shape-as” each other. Also, \tilde{P}_{c,4}, the “same-color-as” relationship, holds as well—because the two component substructures match. Additionally, there is a new relationship: \tilde{P}_{c,6} denotes that the component elements are “same-orientation-as” each other, even though this orientation is different from the one in C_{b}. A further infon now has to describe the internal structure and perceptual/semantic nature of the complex components (here identical) b₁ and b₂.

As these relationships are aggregated, a strong belief-value-set builds for similarity. As there are multiple similarity indicators, these need to be aggregated, again, preferably using a method such as Dempster-Shafer, which allows for evidence aggregation.

As a second example, consider the simple statement: “Mary likes John.” As a belief-value-set is built—abstracted and independent from any single data source—that there is a known entity, Mary, who has some interaction, relationship, or point-of-view with regard to a second known entity, John, the overall belief-value-set is constructed based on three things: (1) that the extracted “Mary” matches the known “Mary,” (2) that the extracted “John” matches the known “John,” and (3) that the relationship between the two is a single-directional one of “likes.” (At this point, nothing is known about whether John likes Mary.)

The matching of the extracted “Mary” to the reference “Mary,” and similarly with the extracted “John” to the reference “John”, is done using the methods previously described.

Next a relationship between Mary and John is asserted. This does not specify the type of relationship; simply that one exists. It may, in fact, be a simple physical proximity—there may be no real particular “relationship,” Mary and John may simply have been observed standing near each other. (As applied to entities extracted from text, the statistical neighborliness of two extracted entities is indicative of a potential relationship, but not an absolute proof. However, multiple statistical proximities—even in text—can be aggregated as “evidence.”)

The immediate focus, however, is on describing the belief in the particular kind of relationship. This is important, because many relationships can be positioned in a kind of “relationship-continuum.” For example, “likes” is part of continuum between “loves” and “hates/despises.” It is also part of a second continuum between “has strong feelings about” and “doesn't really care.” Both are necessary to position the relationship “likes” with any degree of usefulness.

So instead of trying to construct a belief associated with just one point in the relationship continuums, belief is described as it is applied to relationships—in a more broadly scoped sense.

The hypothesis generation system is establishes that for any given relationship between one or more entities, there exist one or more continuums needed to accurately depict the relationship. In the example just given, there are two continuums.

The continuum-space is defined as Ω, so that [Ω={ω₁ . . . ωₙ}, where n is the “dimensionality” of the continuum-space. (In this example, n=2.)

The hypothesis generation system defines that a given relationship exists as a distribution function over a continuum, so that a relationship P (for proposition) is now given as
P={ƒ₁(ω₁), . . . ,ƒₙ(ωₙ)}.
(Note that in the case where a given relationship truly does have unary or a collection of “single” values, rather than a continuum, the system still uses the continuum approach, but define it as populated by a collection of one or more point functions, rather than as a continuous function.)

In the case of the “like” relationship, the proposition “like” now becomes a function ƒ₁ with some distribution over the “love/hate” dimension and also a distribution ƒ₂ over the “has strong feelings/doesn't really care” dimension.

The belief actually becomes a probability function applied to the relationship, essentially asserting a likelihood of belief across each of these dimensions. Thus, the belief that the relationship “like” occurs is expressed as:
beliefdistset={∫bel(ω₁)ƒ₁(ω₁)dω₁, . . . ,∫bel(ω₂)ƒₙ(ω₂)dω₂}
A similar approach is used to define the disbelief that the relationship “likes” exists.

The Dempster-Shafer approach of evidence combination is used to arrive at an aggregate belief Y_{“likes”}. The D-S approach is most important when dealing with social networks, or situations where aggregates of “dispositions” across multiple persons is of value.

The relationship-continuum approach is not restricted to social relationships, or even to relationships described using language. It is equally applicable to describing relationships as might appear within an image, where one region surrounds (whole or partially) another, shares edges (whole or partially) with another, is oriented in the same direction (whole or partially), etc. Thus, a full set of non-emotive and indeed, simply perceptual/syntactic, relationships can be defined.

Further, the relationship-continuum approach just as readily extends to sets of relationships between either extracted, observed, or even hypothetically projected relationships between entities over time. For example, two political parties can be seen as diverging or converging on certain issues. Two military formations can be said to move with regard to one another in various ways. All matters of relationship between two or more entities can typically be defined using distributions over some continua.

Referring now to the previous example, because the resultant term, Y_{“likes”}, is so carefully constructed across a set of distribution continuums, it is most likely to be susceptible to inputs from many sources. In the process of evidence aggregation, it is likely that between any two entities, not only is the specific nature of the relationship likely to receive close attention and be a subject for analysis, but also, there are likely to be multiple relationships. “Likes” can be one. “Supports” can be another. “Has-family-ties-with” can be another.

Because of the diversity of relationships that can exist between any two (or more) entities, according to one embodiment of the invention, the hypothesis generation system first identifies that a relationship between certain entities exists (i.e., validate that there is some Proposition to be made concerning two or more entities, etc.), and then defines the suite of relationships that can be hypothesized, along with the belief-value-set for each.

The belief-value-sets for a set of given Propositions {A,B,X, . . . } between two known entities is defined as:
E={ε_{A},ε_{B},ε_{X}, . . . }.

Because each Proposition can be unique and distinct, the system does not fold the various belief-value-sets for the various propositions into each other.

A separate challenge lies in describing a “degree of correspondence” between structures. Consider the simplest possible structure; e.g., subject, verb/relationship, and object. Various other attributes can be associated with this basic situation; e.g., time, location, etc. To perform matching, the whole structure of the extracted event needs to be matched against some other structure describing a given, reference event. It is convenient if some simple scalar, or even a simple set of scalars (e.g., a belief-value-set) could describe the match of one structure to another—and indeed, they can and shall. However, such a set of scalars, while affording a composite and overview match of both structure and component element matches, suffers when used to determine the cause of any “match deficiency.” This means, if the match is not perfect, it is hard to trace back through the scalars to find where both the goodness of match and lack of match occurred.

In short, when matching structures, the hypothesis generation system provides both an overview of the match, and also a match description that is itself a structure. However, this “match-structure” can be expandable; the simplest forms do not need to be as deep as either of the structures that are being matched one to another. Rather, it can capture the top-level structural match values; e.g., the match between the subjects, the objects, and the relationship or preposition, and also contain match values for other descriptive situation attributes. Thus, the match structure can be represented using the same formalism as used for representing either or both the extracted event and the reference event. The difference is that the “subject” in the match structure is not the same “subject” as the extracted or the reference event, but rather, the degree-of-match between the subject of the extracted event and the subject of the reference event, etc.

Naturally, each of these elements of the “match structure” can itself decompose into more detailed match structures, which should be the case when either or both the extracted or reference event has detailed substructure. Thus, an expansion of the belief-value-set is introduced.

An illustration of the structure matching uses the simple proposition “Mary likes John.”

To formally describe “Mary likes John”, the hypothesis generation system constructs an infon σ as: [symbol]
P,a₁,a₂, . . . ,aₙ,i [symbol]
“likes”, a₁, . . . , aₙ is the set of relationships or attributes attached to the proposition of information about this expression of “likes” (which in this case are Mary and John), along with location (undefined in our example) and time (current-time), and i is an index that tells whether the proposition and its associated attributes is either true (i=1), or not-true (i=0).

Thus, replacing the values in σ specifically for this instance yields: [symbol]
likes,Mary,John,current-time,1 [symbol]
Where, for simplicity, the only attributes created for this infon are the two persons, along with a generic location), and identifying the time as current-time. Also, this proposition is given an “index of 1,” identifying this as a positive-assertion proposition.

The next step is to structure a belief concerning this proposition, where as before, the structure is given as S(B), denoted as: [symbol]
Bel,e^{#},P^{#},a₁^{#},a₂^{#},t^{#},i [symbol] ,
where:

Bel identifies this as a belief,

e# identifies the notion of the specific environment in which the belief is supposed to occur (which in this case is undefined),

P identifies a proposition, and P^{#} refers to a notion of a specific proposition, e.g., “likes,”

a₁ and a₂ identify the arguments of the proposition, in this case Mary and John,

t identifies the time, and t^{#} refers to a notion of a specific time, e.g., “now,” and

i is a unary value as to whether the belief in the proposition, occurring in the referenced environment, at the referenced time, is true or false.

A belief situation, S₁, is identified formally as:
s₁|= [symbol] [symbol] has-belief,Observer,B,t_{B},ε [symbol] [symbol]
ˆ [symbol] [symbol] has-structure,B, [symbol] Bel,e^{#},likes^{#},Mary^{#},John^{#},now^{#},1 [symbol] ,1 [symbol] [symbol]
ˆ [symbol] [symbol] of,e^{#},e,-,t_{B},1 [symbol] [symbol]
ˆ [symbol] [symbol] of,likes^{#},likes,-,t_{B},1 [symbol] [symbol]
ˆ [symbol] [symbol] of, Mary^{#},Mary,-,t_{B},1 [symbol] [symbol]
ˆ [symbol] [symbol] of,John^{#},John^{#},-,t_{B},1 [symbol] [symbol]
ˆ [symbol] [symbol] of,now^{#},t_{B},-, t_{B},1

[symbol]

[symbol]

In this formalism, the use of a “#” parameter refers to the parameter as being a “notion-of.” For example, e^{#} refers to the environment, e, which in this case is not defined.

In the example just used, all of the “notions-of” are uniquely assigned to specific instantiations, with a unitary value for the belief. That is, there is no conflict about the assignments themselves.

The question about the assignment, and the reason that the parameter e is used, relates to the “degree-of-belief” that the Observer (which might be an automated system) has in the overall assignment of belief to whether or not Mary likes John.

There is no conflict in the second line of the equation above; the second line of the equation identifies the belief structure.

The only area where the “belief” is a multivalued parameter (and as will be identified shortly, a structured multivalued parameter) lies in identifying the actual belief that the Observer might actually have in the assertion that Mary likes John.

According to one embodiment of the invention, the hypothesis generation system creates the new “structured belief expression” ε, where ε is given as:
ε= [symbol] ε̅,Ξ [symbol] ,
where ε̅ is the vector variable as previously defined, applying to the overall match of an “extracted entity” to a “reference entity,” where each entity is described as an infon [symbol]
P,a₁,a₂, . . . ,aₙ,i

[symbol]

Accordingly the hypothesis generation system provides a system and method for “condensing” the various beliefs gathered about aspects of the situation into a single belief-value-set.

The hypothesis generation system also provides a structured belief-value-set, Ξ, which provides the “particular belief” associated with matching each component or aspect of the respective infons. One belief-value-set ξ_{S} represents the overall match of the syntactic structures. Additionally, a separate belief-value-set ξ_{P} matches the propositions Π, and one each, ξᵢ, for each of the attributes aᵢ. Further, the system provides an indication of how “deep” the two respective structures and the extent to which they have been matched in depth.

The structured belief-value-set, Ξ, decomposes as:
Ξ= [symbol] ξ_{S},ξ_{P},ξ₁,ξ₂, . . . ξₙ [symbol] .
As each element ξ is a three-value vector, the structured belief-value-set Ξ can also then be represented as a matrix. Since the vector ε̅ is also a three-value vector, the two can be combined so that ε becomes at the highest level the matrix \hat{ε}, given as:
ε=\hat{ε}=[ ε̅, ξ̅_{S}, ξ̅_{P}, ξ̅₁, . . . , ξ̅ₙ]concat-with[indicator-matrix].

The hypothesis generation system determines that the initial value for ε̅ is given as ε̅=[0,0,0], denoting that there is initially neither any belief nor disbelief in the potential match (so that the “uncertainty” U is 1), and that there is no conflict.

The first match is accomplished on the structure itself; to determine simply that the same kinds of structures exist. Because the structures are similar (to the extent of each component entity within the structure being itself a complex entity), the value for ε_{structure} is given initially—as only the top structural levels are evaluated—as ε_{structure}=[0.5,0,0]. Note that the belief for structure matching is given as 0.5 rather than 1.0; this is because the contribution for first-level matching “capped” at a given value, which is selected as 0.5 for this level. Further matches, done at subordinate levels, allow greater contributions. The belief values associated with each component structural entity need to be normalized, and higher-level matches need to be weighted preponderantly more than lower-level matches, and further, the sum of all contributions to the final “belief” must be not greater than 1. Similar approaches apply to disbelief. Conflict is computed using the Dempster-Shafer formalism.

Without addressing deeper substructure matching levels, the previously-gained belief-value-set for structural matching is aggregated with the previous initial belief-value-set, using Dempster-Shafer evidence-aggregation rules, to achieve a result of ε=[0.5,0,0]. However, a matrix of belief-value-sets can also be identified (see example below). The first three columns are reserved for the aggregate, structural, and propositional belief vectors. The remaining n−3 columns are apportioned as follows: Columns 4, . . . , 3+(n−4)/2 are for the belief-value-sets associated with matching the component entities to the reference components. This means that if there are two component entities, columns 4 and 5 are reserved. (Note that n in this example is 8; 3+(n−4)/2=5.) Column 4+(n−4)/2 is reserved to identify whether there are substructures that need to be further matched, and columns 5+(n−4)/2, . . . , n identify whether there is a substructure associated with their respective specific component entities. In these last two types of columns, reserved for identifying the existence of substructure, the first item is a unary (1,0) bit; the remaining elements are set to 0. These values are indicators for further processing only, and are not included in the evidence aggregation process. Evidence aggregation is reserved exclusively for columns 2, . . . , 3+(n−4)/2.

$$ɛ = [ \begin{matrix}- & 0.5 & - & - & - & 1 & 1 & 1 \\ - & 0 & - & - & - & 0 & 0 & 0 \\ - & 0 & - & - & - & 0 & 0 & 0\end{matrix} ]$$

The first column becomes the resultant aggregate match, but is at this point undefined. The second column is the structural match. It can be further refined by matching sub-component structures. The third column is the propositional/relational match. It in itself is an aggregate of the various relationships that can be matched across the component entities. The fourth and fifth columns in this example are used for the component entities; the number of dedicated columns for this task can be expanded as was previously identified. Evidence aggregation proceeds using the Dempster-Shafer method. At the discretion of the practitioner, the various columns can be “weighted” by factors determined by the practitioner as appropriate to the task.

The system disclosed in the present application could be employed in conjunction with a knowledge discovery system such as disclosed in U.S. patent application Ser. No. 11/279,465; U.S. patent application Ser. No. 11/059,643; and U.S. Provisional Patent Application 60/670,225. These three applications are herein incorporated by reference in their entirety. The knowledge discovery systems disclosed in the foregoing applications could be employed to extract entities that are processed by the hypothesis generation system disclosed herein. For example, the knowledge discovery system disclosed and claimed in the foregoing applications could be employed as the extraction processor 10. The knowledge discovery systems could also be used to define the context for the extracted entities. For example, the knowledge discovery systems could be employed as the classification processor 20 and/or the contextual classification processor 25 described herein.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A system for performing hypothesis generation, comprising:
an extraction processor configured to extract an entity from a data set;
an association processor configured to associate the extracted entity with a set of reference entities to obtain a potential association, wherein the potential association between the extracted entity and the set of reference entities is described using a vector-based belief-value-set; and
a threshold processor configured to determine whether a set of belief values of the vector-based belief-value-set exceed a predetermined threshold.

2. The system of claim 1, wherein the threshold processor is further configured to adopt the potential association represented by the vector-based belief-value-set if the set of belief values exceed the predetermined threshold.

3. The system of claim 1, wherein the association processor further comprises a belief generator configured to:
generate an infonic proposition representing the extracted entity;
generate an infonic proposition representing the set of reference entities; and
generate a vector-based belief statement concerning the infonic propositions.

4. The system of claim 1, wherein the association processor further comprises a classification processor configured to:
gather evidence associated with the extracted entity; and
correlate the extracted entity evidence with evidence pre-associated with the set of reference entities.

5. The system of claim 1, wherein the association processor further comprises a contextual classification processor, wherein if the extracted entity is taken from an unstructured data source the contextual classification processor is configured to:
gather key words and noun phrases surrounding the extracted entity from the entire unstructured data source to obtain an extracted entity concept definition; and
correlate the extracted entity concept definition with a set of reference entities concept definitions.

6. The system of claim 5, wherein the contextual classification processor is further configured to:
determine the context of the source of the extracted entity to obtain a global context;
determine the context of items immediately surrounding the extracted entity to obtain a local context;
use the global context to identify the most relevant set of local concepts identified by the local context; and
correlate the most relevant set of local concepts with the context in which the set of reference entities appears.

7. The system of claim 1, wherein the association processor further comprises an entity referencing processor configured to:
identify the extracted entity as situated in a relationship matrix to other extracted entities;
identify the set of reference entities as situated in a relationship matrix to other reference entities; and
compare the relationship matrix of the extracted entity to the relationship matrix of the set of reference entities.

8. The system of claim 1, wherein the extracted entity and the set of reference entities is a person, place or thing.

9. The system of claim 1, wherein the extracted entity is extracted from a structured data set.

10. The system of claim 1, wherein the extracted entity is extracted from an unstructured data set.

11. The system of claim 1, wherein the extracted entity may be defined using attributes and/or keywords related to the extracted entity and the set of reference entities may defined using attributes and/or keywords related to the set of reference entities.

12. A system for performing hypothesis generation, comprising:
an extraction processor configured to extract a complex entity from a data set;
an association processor configured to associate the complex extracted entity with a set of complex reference entities to obtain a potential association wherein the potential association between the complex extracted entity and the set of complex reference entities is described using an aggregated vector-based belief-value-set; and
a threshold processor configured to determine whether a set of belief values of the aggregated vector-based belief-value-set exceeds a predetermined threshold.

13. The system of claim 12, wherein the threshold processor is further configured to adopt the potential association represented by the aggregated vector-based belief-value-set if the set of belief values exceed the predetermined threshold.

14. The system of claim 12, wherein the complex extracted entity and the set of complex reference entities is an event or situation.

15. The system of claim 12, wherein the association processor further comprises a belief generator configured to:
generate an infonic proposition representing the complex extracted entity;
generate an infonic proposition representing the set of complex reference entities; and
generate a vector-based belief statement concerning the infonic propositions.

16. The system of claim 12, wherein the association processor further comprises a structure comparison processor configured to compare the complex extracted entity to the set of complex reference entities based on the structure of the complex extracted entity and set of complex reference entities, to obtain a structure belief-value-set.

17. The system of claim 12, wherein the association processor further comprises a proposition comparison processor configured to compare a set of propositions for the complex extracted entity to a set of propositions for the set of complex reference entities to obtain a proposition belief-value-set.

18. The system of claim 12, wherein the association processor further comprises an component comparison processor, configured to compare a set of component attributes of the complex extracted entity to a set of component attributes of set of complex reference entities to obtain a component belief-value-set.

19. The system of claim 12, wherein the association processor further comprises an aggregation processor for aggregating a structure belief-value-set, a proposition belief-value-set and a component belief-value-set to obtain an aggregated belief-value-set.

20. The system of claim 12, wherein the complex extracted entity may be defined using attributes and/or keywords related to the extracted entity and the set of complex reference entities may defined using attributes and/or keywords related to the reference entity.

21. The system of claim 17, wherein for any given proposition between the complex extracted entity and set of complex reference entities, there exist one or more continuums in which the proposition may be defined.
